(19) United States
(12) Patent Application Publication
(10) Pub. No.: US 2026/0098212 A1
(43) Pub. Date: Apr. 9, 2026

(54) CATALYST STATE DETERMINATION METHOD AND CATALYST STATE DETERMINATION DEVICE

(71) Applicant: IHI Corporation, Tokyo (JP)

(72) Inventor: Tomomi FUJIKAWA, Tokyo (JP)

(73) Assignee: IHI Corporation, Tokyo (JP)

(21) Appl. No.: 19/345,438

(22) Filed: Sep. 30, 2025

(30) Foreign Application Priority Data
Oct. 4, 2024 (JP) 2024-174774

(51) Int. Cl. C10G 2/00; G01K 13/02; G01K 17/06

(52) U.S. Cl. CPC C10G 2/50; G01K 13/02; G01K 17/06; C10G 2300/70

(57) ABSTRACT

A catalyst state determination method includes measuring temperatures of a catalyst heated by generation of hydrocarbons at a plurality of measurement positions in a flow direction of a raw material, in a reactor generating hydrocarbons by bringing the raw material containing carbon dioxide and hydrogen into contact with the catalyst; and determining the state of the catalyst based on the relationship between the plurality of measurement positions and temperatures of the catalyst measured at the plurality of measurement positions.

### CROSS REFERENCE TO RELATED APPLICATIONS

The present application is based on, and claims priority from Japanese Patent Application No. 2024-174774, filed on Oct. 4, 2024, the entire contents of which are incorporated herein by reference.

### BACKGROUND

### 1. Technical Field

The present disclosure relates a catalyst state determination method and a catalyst state determination device.

### 2. Description of the Related Art

Hydrocarbons are widely used as energy sources and raw materials for chemical products, and most hydrocarbons are produced from fossil fuels. However, when products derived from fossil fuels are burned, the concentration of carbon dioxide in the atmosphere increases, which is regarded as a cause of global warming. Hydrocarbons can be produced from raw materials containing carbon dioxide. For example, by producing hydrocarbons from carbon dioxide contained in factory exhaust gas, it is expected that carbon dioxide emissions can be reduced.

Japanese Patent Application Laid-Open No. 2018-8913 discloses a monitoring method for monitoring a state of a catalyst used in a methane production reaction in which carbon dioxide and hydrogen are continuously reacted in the presence of a catalyst to produce methane in a reactor. In the monitoring method, the amount of hydrogen supplied into the reactor is increased at predetermined intervals within a predetermined period of time. Then, the change in the reaction efficiency of the methane production reaction is measured with the increase in the amount of hydrogen supplied, and the state of the catalyst is monitored based on the change in the reaction efficiency.

### SUMMARY

According to the monitoring method described in Japanese Patent Application Laid-Open No. 2018-8913, it is possible to grasp the cause of a decrease in reaction efficiency in the methane production reaction. However, with the conventional monitoring method, it is not possible to predict the future state of the catalyst.

Therefore, it is an object of the present disclosure to provide a catalyst state determination method and a catalyst state determination device capable of determining the state of a catalyst in the future.

A catalyst state determination method according to the present disclosure includes measuring temperatures of a catalyst, heated by generation of hydrocarbons at a plurality of measurement positions in a flow direction of a raw material, in a reactor generating hydrocarbons by bringing the raw material containing carbon dioxide and hydrogen into contact with the catalyst. The catalyst state determination method determines the state of the catalyst based on the relationship between the plurality of measurement positions and temperatures of the catalyst measured at the plurality of measurement positions.

The state of the catalyst may include at least one selected from a group consisting of deterioration state, remaining life, and replacement timing of the catalyst.

The catalyst state determination method may estimate a first peak top position in a current status of use where the temperature of the catalyst reaches a maximum value in the flow direction of the raw material, based on the relationship between the plurality of measurement positions and the temperatures of the catalyst measured at the plurality of measurement positions. The catalyst state determination method may determine the state of the catalyst based on the first peak top position.

The state of the catalyst may be determined based on the relationship between the first peak top position, a second peak top position at which the temperature of the catalyst when starting to use the catalyst reaches a maximum value, and a third peak top position at which the temperature of the catalyst at the replacement timing of the catalyst reaches a maximum value.

The state of the catalyst may be determined based on the first peak top position, and usage time of the catalyst from the second peak top position to the first peak top position.

The catalyst state determination device includes an input unit configured to input temperatures of the catalyst heated by generation of the hydrocarbons in a reactor generating hydrocarbons by bringing a raw material containing carbon dioxide and hydrogen into contact with the catalyst, the temperatures being measured at a plurality of measurement positions in the flow direction of the raw material. The catalyst state determination device includes a controller configured to determine the state of the catalyst based on the relationship between the plurality of measurement positions and the temperatures of the catalyst measured at the plurality of measurement positions.

According to the present disclosure, it is possible to provide a catalyst state determination method and a catalyst state determination device capable of determining the state of a catalyst in the future.

### BRIEF DESCRIPTION OF THE DRAWINGS

FIG. 1 is a block diagram illustrating a catalyst state determination device according to an embodiment.

FIG. 2 is a schematic diagram illustrating a reaction device according to an embodiment.

FIG. 3 is a schematic diagram illustrating the state of a reactor and a measuring unit according to an embodiment.

FIG. 4 is a graph illustrating changes in a temperature peak of a catalyst.

FIG. 5 is a graph for explaining a method of calculating remaining life and a replacement timing of a catalyst.

FIG. 6 is a flowchart illustrating a procedure for determining the remaining life of a catalyst.

FIG. 7 is a flowchart illustrating the procedure for determining the replacement timing of the catalyst.

### DESCRIPTION OF THE EMBODIMENTS

Hereinafter, several exemplary embodiments will be described with reference to the drawings. The dimensional ratios in the drawings are exaggerated for the sake of explanation and may differ from the actual ratios.

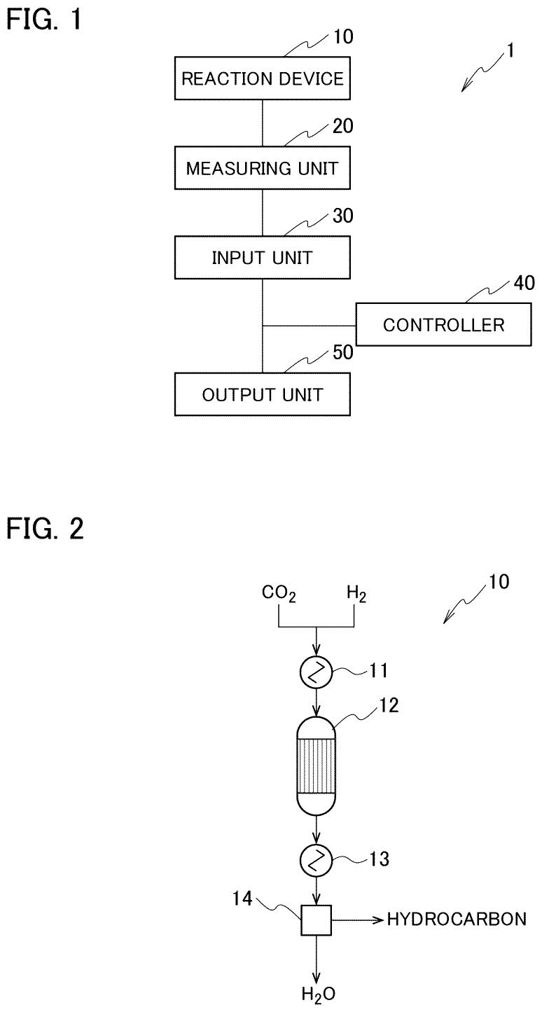

As illustrated in FIG. 1, a catalyst state determination device 1 according to this embodiment includes a reactor 10, a measuring unit 20, an input unit 30, a controller 40, and an output unit 50. The measuring unit 20 and the input unit 30 are electrically communicably connected. The input unit 30, the controller 40, and the output unit 50 are electrically communicably connected.

As illustrated in FIG. 2, the reaction device 10 generates hydrocarbons from a raw material containing carbon dioxide and hydrogen. For example, the reaction device 10 generates methane from a raw material containing carbon dioxide and hydrogen as shown in the following reaction formula (1).

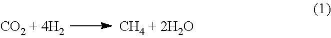

As illustrated in FIG. 2, the reaction device 10 according to this embodiment may include a heater 11, a reactor 12, a cooler 13, and a gas-liquid separator 14. The heater 11 heats a raw material supplied to the reactor 12. The reactor 12 generates hydrocarbons from the raw material containing carbon dioxide and hydrogen. The reactor 12 also generates water vapor as a by-product. The cooler 13 cools a product containing hydrocarbons and water vapor produced in the reactor 12. The gas-liquid separator 14 separates hydrocarbons produced in the reactor 12 from water produced in the reactor 12 and condensed by cooling in the cooler 13.

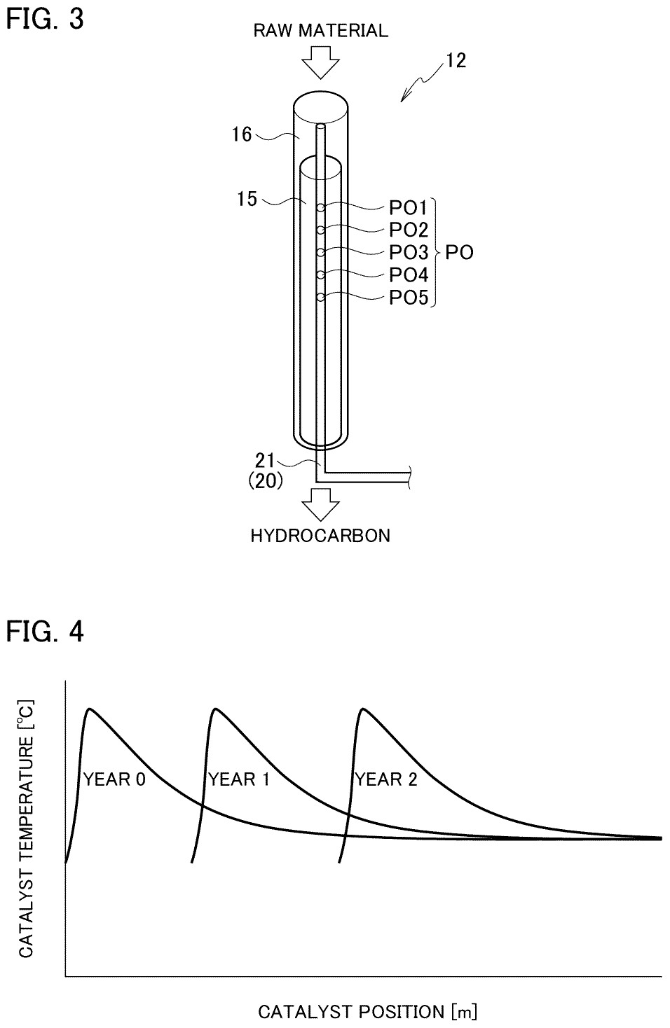

As illustrated in FIG. 3, in this embodiment, the reactor 12 includes a reaction tube 16, and the reaction tube 16 is filled with a catalyst 15. Thus, the raw material passes through the reaction tube 16 and comes into contact with the catalyst 15. Therefore, the reactor 12 produces hydrocarbons by bringing the raw material containing carbon dioxide and hydrogen into contact with the catalyst 15. The carbon dioxide supplied to the reactor 12 may include carbon dioxide recovered from power plants or factories. By using such carbon dioxide as the raw material, not only can the amount of carbon dioxide discharge from power plants or factories be reduced, but also carbon dioxide can be effectively utilized. The hydrogen supplied to the reactor 12 may be obtained by electrolysis of water using renewable energy such as solar power, wind power, and hydraulic power. By using such hydrogen, the emission of carbon dioxide in an overall system can be reduced.

The reactor 12 may include a fixed bed reactor. The fixed bed reactor may be a single tube reactor or a multi-tube reactor, such as a shell-and-tube reactor. The fixed bed reactor may include the reaction tube 16 and a shell (not illustrated) containing the reaction tube 16. The reaction of generating hydrocarbons from raw materials containing carbon dioxide and hydrogen is an exothermic reaction. Therefore, by passing a heating medium such as oil through the shell, the reaction heat generated by generating the hydrocarbons can be drawn away to promote the reaction.

The hydrocarbons produced in the reactor 12 may include at least one of an alkane or an alkene. These hydrocarbons may be produced by methanation reaction or Fisher-Tropsch (FT) reaction. The hydrocarbons produced in the reactor 12 may be used as a sustainable aviation fuel (SAF). At least one of the alkane or the alkene may contain at least one hydrocarbon containing 1 to 100 carbon atoms. At least one of the alkane or alkene may contain at least one hydrocarbon containing 1 to 4 carbon atoms. The alkane may contain, for example, at least one selected from a group consisting of methane, ethane, propane and butane. The alkene may contain, for example, at least one selected from a group consisting of ethylene, propylene, 1-butene, 2-butene, isobutene, and 1,3-butadiene. Methane, ethane and propane can be used as fuel for town gas. In addition, alkenes containing 2 or more, and 4 or less carbon atoms are useful as raw materials for plastics. The reaction products produced in the reactor 12 may contain compounds other than those described above.

The catalyst 15 may contain at least one selected from a group consisting of, for example, nickel catalyst, ruthenium catalyst, iron catalyst, and cobalt catalyst. The catalyst 15 may be selected from the viewpoint of the type of hydrocarbons to be produced. Nickel catalyst or ruthenium catalyst may be used in a methanation reaction to produce methane. Iron and cobalt catalysts can be used for FT reactions. Iron catalysts can mainly produce light hydrocarbons, and cobalt catalysts can mainly produce heavy hydrocarbons including waxes. Iron catalysts can mainly produce alkenes and alkanes, and cobalt catalysts can mainly produce alkanes. Nickel catalysts contain nickel as an active component. Ruthenium catalysts contain ruthenium as an active component. Iron catalysts contain iron as an active component. Cobalt catalysts contain cobalt as an active component. The content of the active component may be 20% by mass or more of the entire catalyst.

The measuring unit 20 measures temperatures of the catalyst 15 heated by hydrocarbon generation at a plurality of measurement positions PO in a flow direction of the raw material. The measuring unit 20 may include a plurality of temperature sensors. The measuring unit 20 may include, for example, a multi-point temperature sensor having a plurality of thermocouples. The measuring unit 20 can measure temperatures of the catalyst 15 at a plurality of measurement positions PO. In this embodiment, the plurality of measurement positions PO include measurement positions PO1 to PO5, and the temperatures of the catalyst 15 are measured at the measurement positions PO. Specifically, the measuring unit 20 measures current temperatures of the catalyst 15 at the measurement positions PO1 to PO5. However, the number of the plurality of measurement positions PO measured by the measuring unit 20 is not particularly limited. The number of the plurality of measurement positions PO may be four or more, for example.

Temperatures of the catalyst 15 heated by the generation of hydrocarbons are measured at the plurality of measurement positions PO in the flow direction of the raw material, and input to the input unit 30. Specifically, the temperatures are measured at the measurement positions PO1 to PO5 by the measuring unit 20, and input to the input unit 30.

The controller 40 is a computer including a central processing unit (CPU), a memory, and an input/output unit. The controller 40 stores a program for determining a state of the catalyst 15, and data, such as the temperatures at the measurement positions PO1 to PO5 referred to in the execution processing of the program. The controller 40 then determines the state of the catalyst 15.

The catalyst 15 deteriorates over time due to sintering, carbon deposition, and catalyst poisoning, causing a decline in the performance of the catalyst 15. Sintering is a phenomenon in which active metal particles in the catalyst 15 aggregate when the catalyst 15 is used at a high temperature, and the specific surface area of the active metal decreases, causing a decline in the performance of the catalyst 15. Carbon deposition is a phenomenon in which the hydrocarbons generated from the raw material containing carbon dioxide covers a surface of an active metal of the catalyst 15, causing a decline in the performance of the catalyst 15. Catalyst poisoning is a phenomenon in which a catalyst poison, such as sulfur contained in the raw material, affects a chemical action of the active metal, causing decline in the performance of the catalyst 15.

FIG. 4 is a graph illustrating changes in a temperature peak of the catalyst 15 heated by hydrocarbon generation. As illustrated in FIG. 4, the reaction of hydrocarbon generation from a raw material containing carbon dioxide is an exothermic reaction, and the temperature of the catalyst 15 rises due to the heat generated in the reaction. The temperature peak of the catalyst 15 is located upstream of the catalyst 15 in year 0 when starting to use the catalyst 15. This may be because, when starting to use the catalyst 15, the reaction mainly occurs upstream of the catalyst 15 where the concentration of the reaction raw material is high. However, the peak of the catalyst 15 shifts to a downstream side of the catalyst 15 with the length of usage time of the catalyst 15. This may be because the performance of the catalyst 15 on the upstream side deteriorates due to sintering, carbon deposition, catalyst poisoning, or the like, and the region where the reaction mainly occurs shifts to the downstream side.

Therefore, in the catalyst state determination device 1 according to this embodiment, the controller 40 determines the state of the catalyst 15 based on the relationship between the plurality of measurement positions PO and the temperatures of the catalyst 15 measured at the plurality of measurement positions PO. As described above, the temperature peak of the catalyst 15 shifts to the downstream side of the catalyst 15 according to the usage time of the catalyst 15. Therefore, the state of the catalyst 15 can be determined from the relationship between the plurality of measurement positions PO and the temperatures of the catalyst 15.

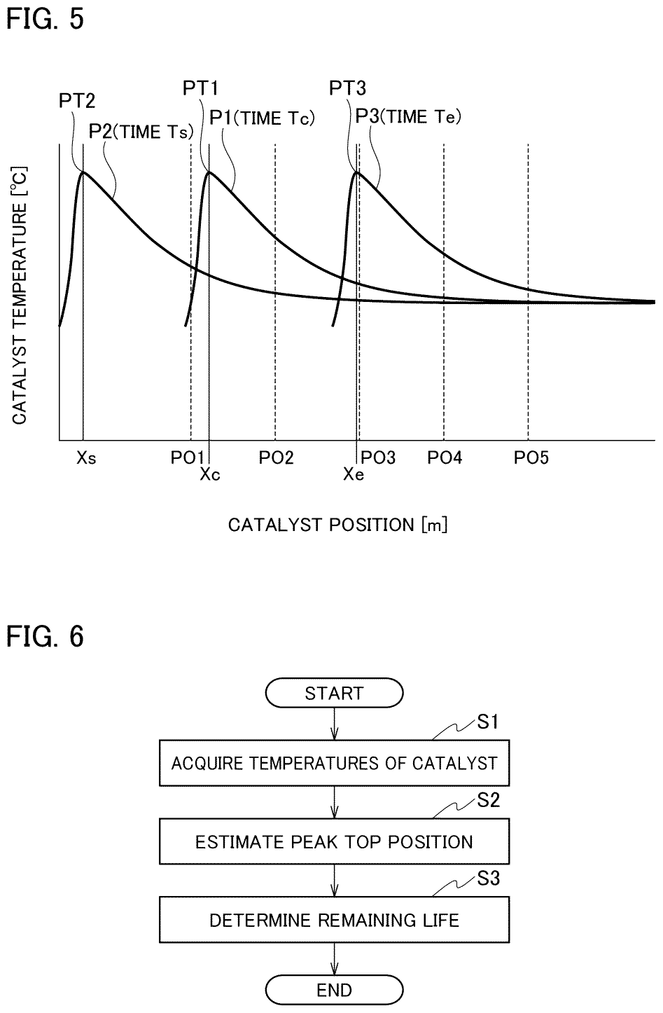

FIG. 5 is an explanatory diagram illustrating a method for calculating a replacement timing of the catalyst 15. In FIG. 5, a peak of the current temperature of the catalyst 15 is indicated by a first peak P1; a temperature peak when starting to use the catalyst 15 is indicated by a second peak P2; and a temperature peak at the replacement timing of the catalyst 15 is indicated by a third peak P3. In FIG. 5, the current usage time of the catalyst 15 is indicated by Tc; the time when starting to use the catalyst 15 is indicated by Ts=0; and the time at the replacement timing of the catalyst 15 is indicated by Te. In FIG. 5, a peak top of the first peak P1 is indicated as a first peak top PT1; a peak top of the second peak P2 is indicated as a second peak top PT2; and a peak top of the third peak P3 is indicated as a third peak top PT3. In FIG. 5, the position of the first peak top PT1 is indicated as a first peak top position Xc; the position of the second peak top PT2 is indicated as a second peak top position Xs; and the position of the third peak top PT3 is indicated as a third peak top position Xe. Peak top here refers to a point at which the temperature is the highest among the peaks. The peak top position refers to the position of the catalyst 15 at the peak top in the flow direction of the raw material.

Each peak can be derived from the current temperatures of the catalyst 15 measured at the plurality of measurement positions PO by the measuring unit 20. Each peak top can be obtained by estimating a point at which the temperature is highest among the peaks. The first peak top position Xc may be determined, for example, to be a position at which the temperature of the catalyst 15 reverses from an upward trend to a downward trend from an upstream side to a downstream side of the catalyst 15. Each peak top position can be obtained by determining the position of the peak top in each peak. The second peak P2 may be a temperature peak when starting to use the catalyst 15 for which the first peak P1 was measured. However, when the same type of catalyst 15 is used and the transition of the same or similar peak is illustrated, the second peak P2 obtained by measuring with a different lot of the catalyst 15 may be used. The third peak P3 is a temperature peak at a replacement timing of the catalyst 15, so that it cannot be measured at the present time. Therefore, the third peak P3 is a temperature peak at a replacement timing of the catalyst 15 measured in advance with the catalyst 15 showing the transition of the same or similar peak.

Here, the present remaining life of the catalyst 15 can be calculated by the following formula (1):

$$Remaining life ( \% ) = ( Xe - Xc ) / ( Xe - Xs ) \times 100 \qquad ( 1 )$$

In mathematical formula (1), Xc is the first peak top position, Xs is the second peak top position, and Xe is the third peak top position. The remaining life of the catalyst 15 is assumed to be 100% at the start of use and 0% at the replacement timing of the catalyst 15.

As can be seen from the mathematical formula (1), the current remaining life of the catalyst 15 can be determined based on the first peak top position Xc. Specifically, the current remaining life of the catalyst 15 can be determined based on the first peak top position Xc, the second peak top position Xs, and the third peak top position Xe.

As described above, the controller 40 may estimate the first peak top position Xc at which the temperature of the catalyst 15 is the maximum value in the current status of use in the flow direction of the raw material, based on the relationship between the plurality of measurement positions PO and the temperatures of the catalyst 15 measured at the plurality of measurement positions PO. Then, the controller 40 may determine the state of the catalyst 15 based on the first peak top position Xc.

Specifically, the controller 40 may determine the state of the catalyst 15 based on the relationship between the first peak top position Xc, the second peak top position Xs at which the temperature of the catalyst 15 when starting to use the catalyst 15 is the maximum value, and the third peak top position Xe at which the temperature of the catalyst 15 at the replacement timing of the catalyst 15 is the maximum value. In the mathematical formula (1) above, the current remaining life of the catalyst 15 is determined using the first peak top position Xc, the second peak top position Xs, and the third peak top position Xe. However, the current state of the catalyst 15 can be roughly understood if the first peak top position Xc is known. Therefore, the state of the catalyst 15 may be determined based only on the first peak top position Xc.

The replacement timing of the catalyst 15 can be calculated by mathematical formula (2) below.

$$Te = Tc + ( Tc - Ts ) \times ( Xe - Xc ) / ( Xc - Xs ) \qquad ( 2 )$$

In the mathematical formula (2) above, Te is the replacement timing (or time) of the catalyst 15; Ts is the time when starting to use the catalyst 15; and Tc is the current usage time of the catalyst 15. Further, Xc is the first peak top position; Xs is the second peak top position; and Xe is the third peak top position.

As can be seen from the mathematical formula (2) above, a current replacement timing of the catalyst 15 can be determined based on the first peak top position Xc. Specifically, the current replacement timing of the catalyst 15 can be determined based on the first peak top position Xc, the second peak top position Xs, the third peak top position Xe, current usage time Tc of the catalyst 15, time Ts when starting to use the catalyst 15, and a replacement timing Te of the catalyst 15.

Thus, the controller 40 may determine the state of the catalyst 15 based on the first peak top position Xc, and the usage time of the catalyst 15 from the second peak top position Xs to the first peak top position Xc. It should be noted that the controller 40 may determine the replacement timing Te of the catalyst 15 based on the first peak top position Xc, similar to the case where the current remaining life of the catalyst 15 is determined.

The output unit 50 outputs data that indicates a state of the catalyst 15 obtained by the controller 40. The output unit 50 may output at least one selected from a group consisting of deterioration state, remaining life, and replacement timing of the catalyst 15. The state of the catalyst 15 output from the output unit 50 may be displayed on a display device such as a monitor (not illustrated).

In this embodiment, the controller 40 estimates the first peak top PT1 of the first peak P1, and determines the state of the catalyst 15 based on the first peak top position Xc. However, the controller 40 may determine that the catalyst 15 is degraded when the measurement position having a temperature higher than a threshold value among the plurality of measurement positions PO is located downstream of a predetermined measurement position. Therefore, it is not absolutely necessary to use the first peak top PT1.

Next, a procedure for determining the remaining life of the catalyst 15 will be described with reference to a flowchart in FIG. 6.

In step S1, the controller 40 acquires temperatures of the catalyst 15 measured at the plurality of measurement positions by the measuring unit 20, and input through the input unit 30.

In step S2, the controller 40 estimates, for example, the first peak top position Xc. The controller 40 may estimate the second peak top position Xs in addition to the first peak top position Xc.

In step S3, the controller 40 determines a state of the catalyst 15 based on the first peak top position Xc. The controller 40 determines the remaining life of the catalyst 15 based on, for example, the first peak top position Xc, the second peak top position Xs, and the third peak top position Xe. Specifically, the controller 40 determines the remaining life of the catalyst 15 based on the mathematical formula (1) above.

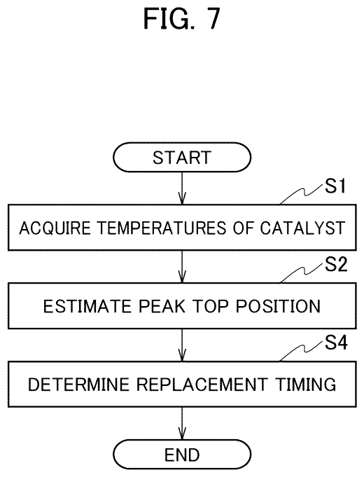

Next, a procedure for determining a replacement timing of the catalyst 15 will be described with reference to a flowchart in FIG. 7.

First, similarly to the above, the controller 40 obtains temperatures in step S1 and estimates a peak top position in step S2.

In step S4, the controller 40 determines a state of the catalyst 15 based on the first peak top position Xc. The controller 40 determines a replacement timing of the catalyst 15 based on, for example, the first peak top position Xc and use time of the catalyst 15. Specifically, the controller 40 determines the replacement timing of the catalyst 15 based on the mathematical formula (2).

This embodiment describes the method of determining the remaining life of the catalyst 15 and the replacement timing of the catalyst 15 by the controller 40. However, based on the first peak top position Xc of the catalyst 15, a degradation state of the catalyst 15 may be determined by an index of the degradation state, such as a degradation degree or a degradation progress of the catalyst 15. Therefore, the state of the catalyst 15 may include at least one selected from a group consisting of the degradation state, the remaining life, and the replacement timing of the catalyst 15.

Next, the operation and effect of the catalyst state determination device 1 according to this embodiment will be described.

A catalyst state determination method includes measuring temperatures of the catalyst 15 heated by generation of hydrocarbons at a plurality of measurement positions PO in a flow direction of a raw material, in the reactor 12 generating hydrocarbons by bringing the raw material containing carbon dioxide and hydrogen into contact with the catalyst 15. The catalyst state determination method determines the state of the catalyst based on the relationship between the plurality of the measurement positions PO and temperatures of the catalyst 15 measured at the plurality of measurement positions PO.

The catalyst state determination device 1 includes, in the reactor 12 that generates hydrocarbons by bringing a raw material containing carbon dioxide and hydrogen into contact with the catalyst 15, the input unit 30 for inputting temperatures of the catalyst 15 heated by generation of the hydrocarbons and the temperatures being measured at a plurality of measurement positions in the flow direction of the raw material. The catalyst state determination device 1 includes the controller 40 for determining the state of the catalyst 15 based on the relationship between the plurality of measurement positions PO and the temperatures of the catalyst measured at the plurality of measurement positions PO.

The temperature peak of the catalyst 15 shifts in a flow direction of the raw material over the usage time of the catalyst 15. Therefore, the controller 40 can determine the state of the catalyst 15 based on the temperatures at the plurality of measurement positions measured in the flow direction of the raw material. With the catalyst state determination method and the catalyst state determination device 1, a future state of a catalyst can be determined.

For example, even in the case of the catalyst 15 with a replacement cycle set to two years, an actual deterioration state of the catalyst 15 varies depending on the use condition of the catalyst 15, and therefore, the catalyst does not necessarily reach its life in 2 years. However, with the catalyst state determination method and the catalyst state determination device 1 according to the present embodiment, the future state of the catalyst can be determined, so that the catalyst 15 can be used beyond the replacement timing depending on the state of the catalyst 15.

The state of the catalyst 15 may include at least one selected from a group consisting of a deterioration state, remaining life, and replacement timing of the catalyst 15. With this configuration, the deterioration state, remaining life, and replacement timing can be determined, so that the catalyst 15 can be efficiently used and the effect of reducing the operating cost of the catalyst 15 can be expected.

Based on the relationship between the plurality of measurement positions PO and the temperatures of the catalyst 15 measured at the plurality of measurement positions PO, the controller 40 may estimate the first peak top position Xc in the current status of use where the temperature of the catalyst 15 is the maximum value in the flow direction of the raw material. Then, the state of the catalyst 15 may be determined based on the first peak top position Xc. The first peak top position Xc is estimated, and the state of the catalyst 15 is determined based on the position of the first peak top position Xc, so that the current state of the catalyst 15 can be more accurately grasped.

The state of the catalyst 15 may be determined based on the relationship between the first peak top position Xc, the second peak top position Xs at which the temperature of the catalyst when starting to use the catalyst 15 is a maximum value, and the third peak top position Xe at which the temperature of the catalyst 15 at the replacement timing of the catalyst is a maximum value. With this configuration, the state of the catalyst 15, such as the remaining life, can be more accurately determined. Therefore, the catalyst 15 can be used more efficiently, and the operation cost of the catalyst 15 can be further reduced.

The state of the catalyst 15 may be determined based on the first peak top position Xc and usage time of the catalyst 15 from the second peak top position Xs to the first peak top position Xc. With this configuration, the state of the catalyst 15, such as the replacement timing, can be more accurately determined. Therefore, the catalyst 15 can be used more efficiently, and the operation cost of the catalyst 15 can be further reduced.

Some embodiments have been described above. However, the embodiments may be modified or modified based on the disclosure above. All the components of the embodiments above and all the features described in the claims may be individually extracted and combined as long as they are consistent with each other.

The present disclosure may, for example, contribute to Goal 13 of the United Nations-led Sustainable Development Goals (SDGs): Take urgent action to reduce climate change and its impacts.

What is claimed is:

1. A catalyst state determination method comprising:
measuring temperatures of a catalyst heated by generation of hydrocarbons at a plurality of measurement positions in a flow direction of a raw material, in a reactor generating hydrocarbons by bringing the raw material containing carbon dioxide and hydrogen into contact with the catalyst; and
determining a state of the catalyst based on a relationship between the plurality of measurement positions and the temperatures of the catalyst measured at the plurality of measurement positions.

2. The catalyst state determination method according to claim 1, wherein the state of the catalyst includes at least one selected from a group consisting of a deterioration state, remaining life, and a replacement timing of the catalyst.

3. The catalyst state determination method according to claim 1, further comprising:
estimating a first peak top position in a current status of use where a temperature of the catalyst is a maximum value in the flow direction of the raw material, based on a relationship between the plurality of measurement positions and the temperatures of the catalyst measured at the plurality of measurement positions; and
determining a state of the catalyst based on the first peak top position.

4. The catalyst state determination method according to claim 3, wherein the state of the catalyst is determined based on a relationship between the first peak top position, a second peak top position at which the temperature of the catalyst when starting to use the catalyst is a maximum value, and a third peak top position at which the temperature of the catalyst at the replacement timing of the catalyst is a maximum value.

5. The catalyst state determination method according to claim 4, wherein the state of the catalyst is determined based on the first peak top position and usage time of the catalyst from the second peak top position to the first peak top position.

6. A catalyst state determination device, comprising:
an input unit configured to input temperatures of a catalyst heated by generation of hydrocarbons in a reactor generating hydrocarbons by bringing a raw material containing carbon dioxide and hydrogen into contact with the catalyst, the temperatures being measured at a plurality of measurement positions in the flow direction of the raw material; and
a controller configured to determine the state of the catalyst based on the relationship between the plurality of measurement positions and the temperatures of the catalyst measured at the plurality of measurement positions.
